(19) United States
(12) Patent Application Publication
(10) Pub. No.: US 2003/0024828 A1
(43) Pub. Date: Feb. 6, 2003

(54) Sterilizing method and electrolyzed water producing apparatus

(76) Inventors: Yasuhito Kondo, Ora-gun (JP); Hiroyuki Umezawa, Ota-shi (JP); Tomohito Koizumi, Ota-shi (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/197,213

(22) Filed: Jul. 18, 2002

(30) Foreign Application Priority Data
Jul. 18, 2001 (JP) 217921/2001
Aug. 27, 2001 (JP) 256259/2001

(51) Int. Cl. C02F 1/461

(52) U.S. Cl. 205/742

(57) ABSTRACT

There are provided a sterilizing method which can sterilize bacteria such as Legionella, chlorine resistant bacteria, spores and protozoa, which are bred in bathrooms and the like in particular, using bactericidal water having a high sterilizing effect, and which can avoid an accident, while using a chlorine agent, caused by generation of poisonous chlorine gas due to mixing with an acid agent, and further an electrolyzed water producing apparatus. The gist is to produce electrolyzed water containing hypohalogenous acid and active oxygen such as ozone by electrolyzing water to be electrolyzed, such as tap water, thereby to perform sterilization using the produced electrolyzed water.

### BACKGROUND OF THE INVENTION

The present invention relates to a method of performing sterilization using bactericidal water containing hypohalogenous acid, and an electrolyzed water producing apparatus for producing the bactericidal water which realizes such a method.

Recently, problems of infectious diseases caused by bacteria, such as Legionella, which are bred in bathrooms and the like in particular, have been drawing attention. Humidity and temperature environments in the bathrooms activate growing of mold and propagation of bacteria such as Legionella, and it is considered that those mold and Legionella enter into the human bodies and cause infectious diseases. Generally, mold and Legionella bred in the high temperature and humidity environments of the bathrooms and the like adhere to bathtubs and tiles and then get mixed into hot water in the bathtubs. By inhaling steam from the hot water, the bacteria invade into the human bodies.

Similarly, in other water using places such as kitchens, small refuse pieces of foods, water and the like, when rotten, cause the breeding of bacteria.

Further, the bacteria such as Legionella adhere to air conditioners, air cleaners, ventilators and the like. Through operations of these apparatuses, the bacteria are discharged into rooms from blow openings thereof and float in the air. There has also been a problem that infectious diseases are induced due to these floating bacteria.

Therefore, in general, chlorine (halogen) disinfectants are spread over the bathtubs, tiles, kitchens and further the blow openings of the air conditioners and the like where the mold and the bacteria such as Legionella are adhered, thereby to annihilate the mold and the bacteria and to prevent further breeding thereof.

Chlorine disinfectants generally used are adjusted by addition of agents such as sodium hypochlorite, and many of them are adjusted to alkaline. There has been a problem of generation of poisonous chlorine gas due to mixing with an acid agent, which led to an accident while using the chlorine disinfectant. There has also been a problem that it is difficult for the chlorine disinfectants to exterminate chlorine resistant bacteria, spores, protozoa and the like.

Therefore, as another sterilizing method, there has been known a sterilizing method using silver ions as bactericidal metal ions. In this sterilizing method using silver ions, tap water as water to be electrolyzed is reserved in a container, the tap water is subjected to electrolysis using silver electrodes immersed in the tap water thereby to produce silver ions in the tap water, then the tap water containing silver ions is spread so as to perform sterilization.

However, in the foregoing sterilizing method, there has been a problem that the silver electrodes are eluted during electrolysis, and thus even when switching the electrodes, the electrodes become unusable due to the elution thereof so that the bactericidal effect is lowered. Further, there has also been a problem that since relatively expensive noble metal is used for the electrodes, the high cost is resulted when used over a long period.

### SUMMARY OF THE INVENTION

Therefore, the present invention has been made for solving the conventional technical problems, and has an object to provide a sterilizing method which can perform sterilization using bactericidal water having a high sterilizing effect and without using an agent, and further provide an electrolyzed water producing apparatus.

The sterilizing method of the present invention is characterized by performing sterilization using electrolyzed water containing hypohalogenous acid and active oxygen.

According to this invention, the sterilization is carried out using the electrolyzed water containing hypohalogenous acid and active oxygen, so that in comparison with performing sterilization using a hypochlorous acid agent, the sterilization can be performed using bactericidal water with an extremely high sterilizing effect by using the electrolyzed water immediately after production thereof. As a result, even the spores and the like can be exterminated, which was difficult for the sterilizing method using the agent.

Further, since the sterilization is carried out without using the agent, there is raised no problem of causing harmfulness to environment.

According to another aspect of the present invention, in addition to the foregoing, the sterilizing method is characterized by immersing electrolyzing electrodes in water to be electrolyzed, causing a current to flow in the electrolyzing electrodes to produce hypohalogenous acid and active oxygen in the water to be electrolyzed, thereby to produce the electrolyzed water, then in a short term, performing the sterilization using the electrolyzed water.

According to this aspect of the invention, in addition to the foregoing, the electrolyzing electrodes are immersed in the water to be electrolyzed, the current is caused to flow in the electrolyzing electrodes to produce hypohalogenous acid and active oxygen in the water to be electrolyzed, thereby to produce the electrolyzed water, then in a short term, the sterilization is performed using the electrolyzed water. Thus, the sterilization can be performed using high concentration hypohalogenous acid and active oxygen immediately after production thereof in the electrolyzed water, so that the sterilizing effect can be improved.

According to another aspect of the present invention, in addition to the foregoing, the sterilizing method is characterized by adding a substance containing halogen into the water to be electrolyzed, thereby to cause the electrolyzed water to have a high concentration.

According to this aspect of the invention, in addition to the foregoing, since the substance containing halogen is added into the water to be electrolyzed, thereby to cause the electrolyzed water to have the high concentration, the electrolyzed water with high concentration hypohalogenous acid and active oxygen can be easily obtained, so that the sterilizing effect can be further improved.

The electrolyzed water producing apparatus of the present invention comprises a portable discharge container including a reservoir portion for reserving water to be electrolyzed, a pair of or a plurality of electrolyzing electrodes provided in the reservoir portion so as to be immersed in the water to be electrolyzed, and a discharge portion for discharging a liquid in the reservoir portion to the exterior, wherein a current is caused to flow in the electrolyzing electrodes to produce hypohalogenous acid and active oxygen in the water to be electrolyzed.

According to this invention, there is provided the portable discharge container including the reservoir portion for reserving the water to be electrolyzed, the pair of or the plurality of electrolyzing electrodes provided in the reservoir portion so as to be immersed in the water to be electrolyzed, and the discharge portion for discharging the liquid in the reservoir portion to the exterior, wherein the current is caused to flow in the electrolyzing electrodes to produce hypohalogenous acid and active oxygen in the water to be electrolyzed. Thus, by taking the discharge container in hands, the electrolyzed water produced in the reservoir portion can be easily discharged to a place where sterilization is required, thereby to easily sterilize such a place.

As a result, the usability of the electrolyzed water is improved. Further, since the electrolyzed water can be used immediately after production thereof from the water to be electrolyzed, the sterilizing effect is improved.

According to another aspect of the present invention, in addition to the foregoing, the electrolyzed water producing apparatus is characterized in that a power supply portion for energizing the electrolyzing electrodes of the discharge container from the exterior is provided as a separate member from the discharge container.

According to this aspect of the invention, in addition to the foregoing, since the power supply portion for energizing the electrolyzing electrodes of the discharge container from the exterior is provided as a separate member from the discharge container, it is possible to reduce weight of the discharge container itself and also simplify the structure thereof. Further, since the discharge container is lightweight, the usability thereof is further improved.

According to another aspect of the present invention, in addition to the foregoing, the electrolyzed water producing apparatus is characterized in that the discharge container is unified with a power supply for energizing the electrolyzing electrodes.

According to this aspect of the invention, in addition to the foregoing, since the discharge container is unified with the power supply for energizing the electrolyzing electrodes, the structure is simplified to reduce generation of failure.

According to another aspect of the present invention, in addition to the foregoing, the electrolyzed water producing apparatus is characterized in that a controller is further provided for controlling energization of the electrolyzing electrodes, and the controller is capable of changing a concentration of electrolyzed water produced in the reservoir portion.

According to this aspect of the invention, in addition to the foregoing, since the controller is further provided for controlling energization of the electrolyzing electrodes, and further since the controller is capable of changing the concentration of the electrolyzed water produced in the reservoir portion, the concentrations of hypohalogenous acid and active oxygen can be adjusted depending on a purpose of using the electrolyzed water.

According to another aspect of the present invention, in addition to the foregoing, the electrolyzed water producing apparatus is characterized in that the controller is provided in the power supply portion.

According to this aspect of the invention, in addition to the foregoing, since the controller is provided in the power supply portion, it is possible to further reduce weight of the discharge container and further simplify the structure thereof.

According to another aspect of the present invention, in addition to the foregoing, the electrolyzed water producing apparatus is characterized in that the discharge container has an operating portion, and that, based on an operation of the operating portion, electrolyzed water produced in the reservoir portion is forced into the discharge portion so as to be discharged in a spray manner.

According to this aspect of the invention, in addition to the foregoing, the discharge container has the operating portion, and based on an operation of the operating portion, the electrolyzed water produced in the reservoir portion is forced into the discharge portion so as to be discharged in a spray manner. Thus, the discharge container can be improved in operatability thereof. Further, the electrolyzed water can be discharged from the discharge container without forming it into a state of mist, so that a user can be prevented from directly inhaling the electrolyzed water.

### BRIEF DESCRIPTION OF THE DRAWINGS

FIG. 1 is an explanatory diagram showing an outline of an electrolyzed water producing apparatus according to the present invention;

FIG. 2 is a front view of a discharge container of the electrolyzed water producing apparatus according to the present invention;

FIG. 3 is a bottom view of the discharge container of the electrolyzed water producing apparatus according to the present invention;

FIG. 4 is a plan view of a power supply portion of the electrolyzed water producing apparatus according to the present invention;

FIG. 5 is an electric block diagram of a microcomputer and an AC/DC converter of the electrolyzed water producing apparatus according to the present invention;

FIG. 6 is a diagram showing survival rate of bacteria in terms of elapsed time after production; and

FIG. 7 is a diagram showing survival rate of bacteria in terms of free chlorine concentration.

### DETAILED DESCRIPTION OF THE PREFERRED EMBODIMENT

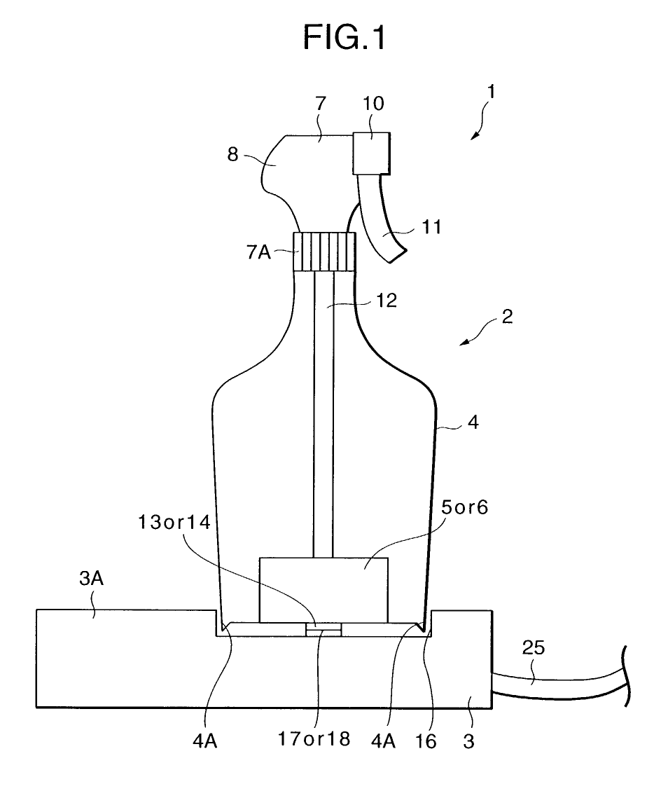

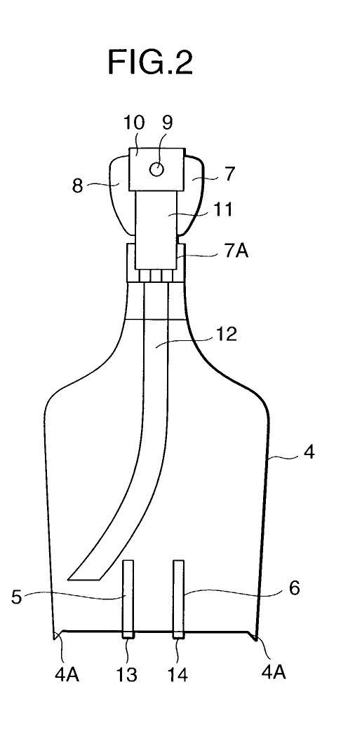

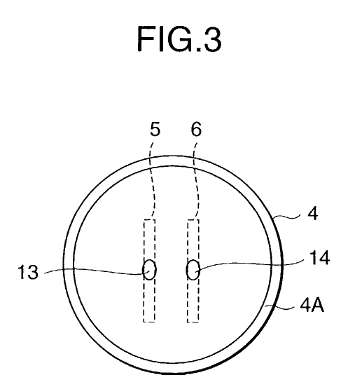

Now, a preferred embodiment of the present invention will be described in detail with reference to the accompanying drawings. FIG. 1 is an explanatory diagram showing an outline of an electrolyzed water producing apparatus 1 for realizing a sterilizing method of the present invention, FIG. 2 is a front view of a discharge container 2 and FIG. 3 is a bottom view of the discharge container 2. In this embodiment, the electrolyzed water producing apparatus 1 comprises the discharge container 2 which is portable, and a power supply portion 3.

The discharge container 2 comprises a reservoir portion 4 for reserving water (liquid) to be electrolyzed, electrolyzing electrodes 5 and 6 which will be described later in detail, and a discharge portion 7 for discharging electrolyzed water (liquid) produced in the reservoir portion 4, to the exterior. The reservoir portion 4 is a receptacle with a filling opening formed, for example, at an upper end thereof for introducing water to be electrolyzed (tap water). An outer side of the filling opening is formed with a thread (not shown) for engaging with an inner thread (not shown) of a cap 7A to detachably fix the cap 7A. The cap 7A is attached to the discharge portion 7 as a cover member, and provided with a so-called gas vent hole or a pressure valve (not shown) for relieving gas within the reservoir portion 4 to the exterior.

For ensuring portability of the discharge container 2 even when the electrolyzed water is filled in the reservoir portion 4, the volume of the reservoir portion 4 is set to about 500 ml, for example. Further, as shown in FIGS. 2 and 3, the bottom of the reservoir portion 4 is formed with a rim portion 4A projecting downward to a small extent, so that inner portions of the bottom of the reservoir 4 space apart a given interval from the plane on which the reservoir portion 4 is placed.

The discharge portion 7 is a so-called spray type discharge member, and comprises a body 8 to which the cap 7A is attached, a discharge member 10 formed with a discharge hole 9 in front of the body 8, an operating portion 11 mounted to the discharge member 10 for implementing a discharge operation, and a feed pipe 12 received in the reservoir portion 4 and immersed in the water to be electrolyzed within the reservoir portion 4.

Accordingly, through operation of the operating portion 11 of the discharge portion 7, the water to be electrolyzed can be injected in a spray manner to the exterior from the discharge hole 9 via the feed pipe 12 immersed in the water to be electrolyzed.

On the other hand, the electrolyzing electrodes 5 and 6 are provided at the bottom within the reservoir portion 4. Each electrolyzing electrode is, for example, a noble metal electrode made of platinum or an alloy of platinum and iridium, or a noble metal coated electrode coated with platinum or an alloy of platinum and iridium, which is formed into a plate-like shape, for example. Both electrolyzing electrodes have the same structure. In this embodiment, a pair of the electrolyzing electrodes 5 and 6 are provided at the bottom within the reservoir 4, but a plurality of electrolyzing electrodes other than two may be provided.

The electrolyzing electrodes 5 and 6 are provided with terminals 13 and 14, respectively, which extend through holes (not shown) formed in the bottom of the reservoir portion 4. The lower end of each of the terminals 13 and 14 is positioned higher than the lower end of the rim portion 4A of the reservoir portion 4. With this arrangement, when the discharge container 2 is placed on a flat surface of, such as, a table, it can be stably placed.

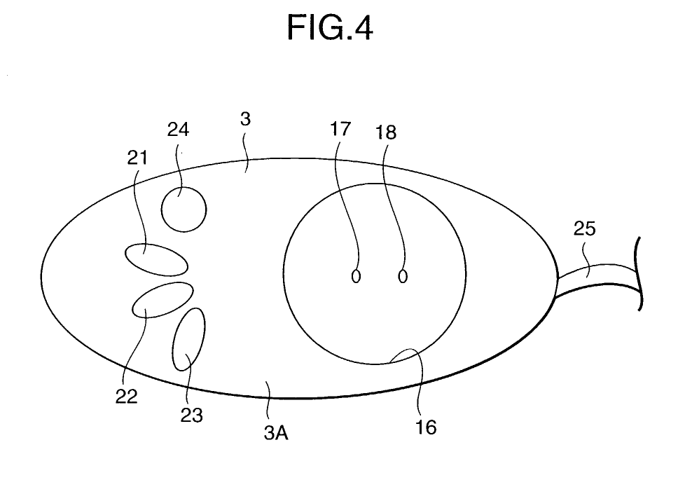

Now, the power supply portion 3 will be described with reference to FIG. 4. FIG. 4 is a plan view of the power supply portion 3. The power supply portion 3 is a direct current supply device for supplying a direct current to the electrolyzing electrodes 5 and 6 of the discharge container 2, and comprises a body 3A provided therein with a microcomputer 15 as a controller and an AC/DC converter 20.

On an upper surface of the body 3A is formed a recess portion 16 for placing thereon the discharge container 2. The recess portion 16 has a size slightly greater than a size of the bottom wall of the discharge container 2, and is provided, for example, at its center portion with terminals 17 and 18 projecting upward for contacting with the terminals 13 and 14 provided at the bottom of the discharge container 2.

Further, on the upper surface of the body 3A are provided operating switches (three in this embodiment) for controlling a current supply to the electrolyzing electrodes 5 and 6 of the discharge container 2 placed in the recess portion 16, that is, controlling ON/OFF of the power supply for the electrolyzing electrodes 5 and 6. The operating switches include a strong switch 21, an intermediate switch 22 and a weak switch 23. Through operation of each of the switches 21, 22, 23, the corresponding power is supplied to the electrolyzing electrodes 5 and 6, and through further same operation thereof, the power supply to the electrolyzing electrodes 5 and 6 is stopped.

Specifically, voltage values of three levels are set to the switches 21, 22, 23, respectively. When the strong switch 21 is operated, the highest voltage, for example, 12V is applied across the electrolyzing electrodes 5 and 6. When the intermediate switch 22 is operated, the voltage lower than that applied by the strong switch 21 is applied across the electrolyzing electrodes 5 and 6. Further, when the weak switch 23 is operated, the voltage lower than that applied by the intermediate switch 22 is applied across the electrolyzing electrodes 5 and 6.

Further, an element 24 arranged on the upper surface of the body 3A is an LED (light emitting diode) for notifying a termination of electrolysis. A plug socket 25 for supplying AC power is further provided at a side of the body 3A.

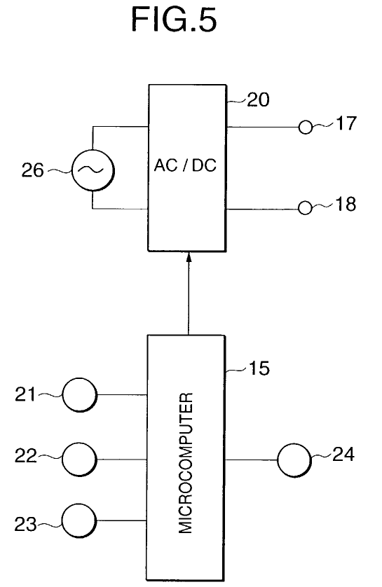

Now, the microcomputer 15 and the AC/DC converter 20 will be described with reference to FIG. 5 showing an electric block diagram of the microcomputer 15 and the AC/DC converter 20. The microcomputer 15 arranged in the body 3A has a timer. The foregoing operating switches, i.e. the strong switch 21, the intermediate switch 22 and the weak switch 23, are connected to an input side of the microcomputer 15, while the LED 24 is connected to an output side thereof. Further, the microcomputer 15 is connected to the AC/DC converter 20.

The AC/DC converter 20 has an input side connected to an AC power supply 26, and an output side connected to the terminals 17 and 18 provided in the recess portion 16 of the body 3A. The microcomputer 15 executes a control with the power supplied from the AC/DC converter 20.

Now, a using manner of the present invention will be described. First, the cap 7A of the discharge container 2 is opened thereby to introduce tap water into the reservoir portion 4 as water to be electrolyzed. In this embodiment, it is assumed that the tap water contains about 30 ppm chlorine (one example of halogen). Then, the filling opening of the reservoir portion 4 is closed by the cap 7A of the discharge container 2, and the discharge container 2 is placed in the recess portion 16 of the power supply portion 3. By operating one of the operating switches 21, 22, 23, the microcomputer 15 controls the AC/DC converter 20 based on the voltage value set to the operated switch, so that the corresponding current is supplied to the terminals 17 and 18 via the AC/DC converter 20. The terminals 17 and 18 supply the current to the electrolyzing electrodes 5 and 6 via the terminals 13 and 14 provided at the bottom of the discharge container 2.

As a result, since the tap water reserved in the reservoir portion 4 contains chloride ions as halide ions, chloride ions emit electrons to produce chlorine at the electrolyzing electrode 5 or 6 serving as an anode. Thereafter, this chlorine dissolves in the water to produce hypochlorous acid as hypohalogenous acid.

Further, since, as described above, each of the electrolyzing electrodes 5 and 6 is a noble metal electrode made of platinum or an alloy of platinum and iridium, or a noble metal coated electrode coated with platinum or an alloy of platinum and iridium, and since chloride ions exist in the tap water as water to be electrolyzed, the electric potential increases to produce active oxygen such as ozone at the electrolyzing electrode 5 or 6 serving as the anode.

In the present invention, an elution type electrode is not used for either of the electrolyzing electrodes 5 and 6. Thus, an exchange of electrode due to elution is not required so that a maintenance burden is improved. Oxygen and hydrogen produced through electrolysis of the tap water as water to be electrolyzed are relieved to the exterior via the foregoing gas vent hole or pressure valve provided at the cap 7A of the discharge portion 7.

The microcomputer 15, using the timer, monitors a lapse of time from an operation of one of the operating switches 21, 22, 23, and after a lapse of a predetermined time, i.e. about one minute in this embodiment, stops supplying the power to the electrolyzing electrodes 5 and 6 to terminate the electrolysis, assuming that the electrolyzed water containing hypochlorous acid and active oxygen such as ozone has been produced in the discharge container 2. On this occasion, the microcomputer 15 turns on the LED 24 for notifying a user of the termination of electrolysis.

Every time one of the operating switches 21, 22, 23 is operated to carry out electrolysis, the microcomputer 15 controls the AC/DC converter 20 to switch polarity of the terminals 17 and 18.

With this arrangement, since polarity of the electrolyzing electrodes 5 and 6 is switched every time electrolysis is performed, fixing of a substance such as bleaching powder generated at a cathode due to electrolysis is prevented, so that lowering of the electrolytic efficiency caused by lowering of the current flowing efficiency of the electrodes 5 and 6 can be prevented beforehand.

By operating the operating portion 11 of the discharge container 2, the electrolyzed water thus produced is injected over a place where sterilization is required, such as a bathroom, a toilet room, a kitchen or a foliage plant, thereby to perform the sterilization.

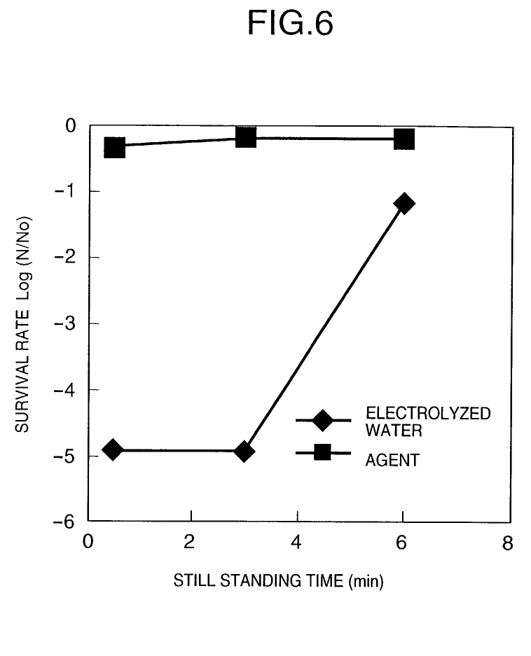

Referring now to FIG. 6, the bactericidal effects of the electrolyzed water obtained by the present invention and the conventional chlorine disinfectant using an agent will be described in terms of a lapse of time. FIG. 6 shows a result of an experiment where sterilization of yeast as an example of bacteria was carried out using the electrolyzed water and a chlorine disinfectant agent each having 0.6 mg/l free chlorine concentration.

According to the result, the survival rate of yeast was −0.2 Log(N/N0) in case of the agent immediately after production thereof. Then, the survival rates of yeast 3 minutes after the production and 6 minutes after the production had no substantial difference in comparison with that immediately after the production.

On the other hand, in case of the electrolyzed water immediately after production thereof, the survival rate of yeast was −5 Log(N/N0) and thus the bactericidal effect was significant. Further, the survival rate of yeast 3 minutes after the production was also −5 Log(N/N0) and thus the bactericidal effect was still significant. In contrast, the survival rate of yeast 6 minutes after the production was −1.2 Log(N/N0), which was better than the survival rate achieved by the agent, but was lowered in comparison with the survival rates immediately after the production and 3 minutes after the production.

Accordingly, when used in a short period, i.e. immediately after the production to at least 6 minutes after the production, the electrolyzed water of the present invention can realize the sterilization using high concentration hypochlorous acid and active oxygen such as ozone, so that the bactericidal effect can be remarkably improved in comparison with the conventional chlorine agent.

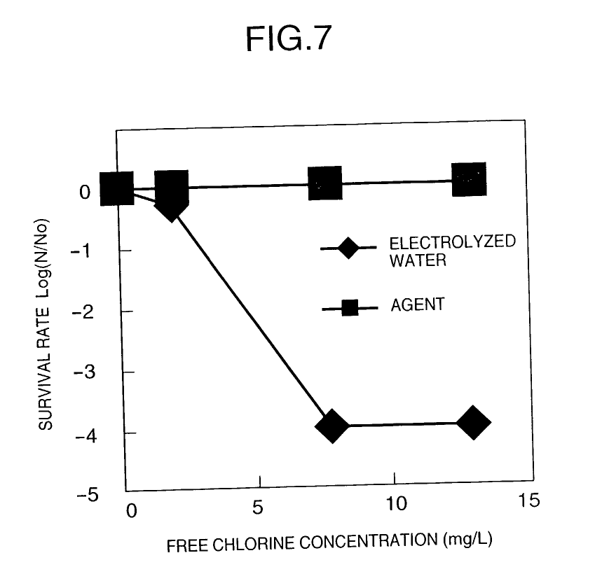

FIG. 7 is a diagram showing bactericidal effects for bacillus subtilis spores achieved by the electrolyzed water and the chlorine agent. The bacillus subtilis spores are chlorine resistant bacteria. Thus, even when the free chlorine concentration was increased to a high value of 13 mg/l, the chlorine disinfectant being the chlorine agent could not exterminate the bacillus subtilis spores at all. In contrast, the electrolyzed water of the present invention produced immediately after production thereof could achieve the survival rate of the bacillus subtilis spores at −0.2 Log(N/N0) even when the free chlorine concentration was about 2.5 mg/l. Then, the free chlorine concentration was increased by gradually increasing the electrolyzing time or the applying voltage. When the free chlorine concentration was about 7.5 mg/l, the survival rate of the bacillus subtilis spores was reduced to −4 Log(N/N0).

Even when the free chlorine concentration of the electrolyzed water was increased to a higher value of about 14 mg/l, the survival rate of the bacillus subtilis spores remained at −4 Log(N/N0).

As seen from the foregoing, since the electrolyzed water immediately after production thereof contains the high concentration of hypochlorous acid having a high residual property and active oxygen such as ozone having a low residual property, even when the free chlorine concentration thereof is the same as that of the chlorine agent, its bactericidal effect is extremely high and thus it can exterminate the spores which can not be exterminated by an agent of hypochlorous acid.

Further, since the electrolyzed water in the present invention is the electrolyzed water immediately after production thereof, the sterilization can be carried out using the bactericidal water with an extremely high sterilizing effect, in comparison with performing the sterilization using an agent of hypochlorous acid adjusted to alkaline in advance, for example.

Further, since the electrolyzed water can prevent generation of poisonous chlorine gas which is caused by mixing with an acid agent, and since the electrolyzed water is obtained through electrolysis of the tab water, there will be raised no problem of causing harmfulness to environment, in contrast to using the agent.

When using the electrolyzed water producing apparatus 1, one of the operating switches 21, 22, 23 of the power supply portion 3 is operated, then the electrolyzed water produced after a lapse of a predetermined time, i.e. about one minute in this embodiment, is used for sterilization. Thus, the electrolyzed water immediately after production thereof, having an extremely high bactericidal effect, can be used for the sterilization without causing an energy loss as compared with constantly performing electrolysis.

In the present invention, as described above, the concentrations of the electrolyzed water produced in the reservoir portion 4 can be variably set by operating each of the operating switches 21, 22, 23. Thus, depending on a purpose of using the electrolyzed water, the concentrations of hypochlorous acid and active oxygen such as ozone can be adjusted. Other than the adjustment of the concentration of hypochlorous acid based on a difference in applying voltage by means of the operating switches 21, 22, 23, the concentration of hypochlorous acid may also be adjusted based on a difference in electrolysis time.

If the electrolyzed water is used with the concentration of hypochlorous acid of a further increased value, a substance containing chlorine, such as salt (sodium chloride), may be added into the water to be electrolyzed so that the electrolyzed water with high concentration hypochlorous acid can be obtained.

This electrolyzed water with high concentration hypochlorous acid can also be used for removing stains of clothes and the like.

Further, in the electrolyzed water producing apparatus 1 of the present invention, the electrolyzed water is produced from the water to be electrolyzed in the discharge container 2 which is portable. Thus, by taking the discharge container 2 in hands immediately after production of the electrolyzed water, the electrolyzed water produced in the reservoir portion 4 can be easily discharged to a place where sterilization is required, thereby to easily sterilize such a place.

Accordingly, the electrolyzed water can be brought in and spread wherever a user wishes, so that the usability is improved. Thus, a bathroom, a toilet room, a kitchen and the like can be readily sterilized, and therefore, they can be kept sanitary. Further, the electrolyzed water can be used immediately after production thereof from the water to be electrolyzed, so that the bactericidal effect is improved. Moreover, since the residual property of hypochlorous acid is high, breeding of bacteria after the sterilization can also be prevented.

On the other hand, since the residual property of active oxygen such as ozone produced by electrolysis is low, if the electrolyzed water is transferred from the discharge container 2 into another container, active oxygen disappears. However, according to the present invention, the electrolyzed water can be spread directly from the discharge container 2 where active oxygen such as ozone is produced. Thus, sterilization can be carried out without losing the bactericidal effect achieved by active oxygen such as ozone.

Further, since the discharge container 2 and the power supply portion 3 for energizing the electrolyzing electrodes 5 and 6 of the discharge container 2 from the exterior are provided as separate members, it is possible to reduce weight of the discharge container 2 itself and also simplify the structure thereof. Accordingly, since the discharge container 2 is lightweight, the usability thereof is further improved.

Further, since the microcomputer 15 as a controller is provided in the power supply portion 3, it is possible to further reduce weight of the discharge container 2 and further simplify the structure thereof.

In this embodiment, the electrolyzed water producing apparatus 1 has the discharge container 2 and the power supply portion 3 as separate members. However, the discharge container 2 and the power supply for energizing the electrolyzing electrodes 5 and 6 provided in the discharge container 2 may be formed integral with each other. In this case, the power supply may be a secondary battery, a battery, a DC power supply or an AC power supply.

In this case, since the discharge container 2 and the power supply are unified with each other, it is not necessary to adopt the structure wherein the terminals of the power supply and the terminals of the electrodes 5 and 6 contact with each other. Thus, the structure is simplified to reduce generation of failure.

Further, since the discharge container 2 of the present invention is of a so-called spray type, a simple operation of the operating portion 11 causes the electrolyzed water produced in the reservoir 4 to be forced into the discharge portion 7 and then discharged to the exterior through the discharge hole 9. Thus, the discharge container 2 can be improved in operatability thereof. Further, the electrolyzed water can be discharged from the discharge container 2 without forming it into a state of mist, so that a user can be prevented from directly inhaling the electrolyzed water.

In the foregoing embodiment, chlorine is used as an example of halogen, chloride ion is used as an example of halide ion, and hypochlorous acid is produced as an example of hypohalogenous acid. However, halogen other than chlorine, such as fluorine, bromine and iodine, may also be used in the present invention. Specifically, as hypohalogenous acid, the present invention is not limited to hypochlorous acid used in the foregoing embodiment.

As described above in detail, according to the sterilizing method of the present invention, the sterilization is carried out using the electrolyzed water containing hypohalogenous acid and active oxygen, so that in comparison with performing sterilization using the hypochlorous acid agent, the sterilization can be performed using the bactericidal water with the extremely high sterilizing effect by using the electrolyzed water immediately after production thereof. As a result, even the spores and the like can be exterminated, which was difficult for the sterilizing method using the agent.

Further, since the sterilization is carried out without using the agent, there will be raised no problem of causing harmfulness to environment.

According to another aspect of the present invention, in addition to the foregoing, the electrolyzing electrodes are immersed in the water to be electrolyzed, the current is caused to flow in the electrolyzing electrodes to produce hypohalogenous acid and active oxygen in the water to be electrolyzed, thereby to produce the electrolyzed water, then in a short term, the sterilization is performed using the electrolyzed water. Thus, the sterilization can be performed using high concentration hypohalogenous acid and active oxygen immediately after production thereof in the electrolyzed water, so that the sterilizing effect can be improved.

According to another aspect of the present invention, in addition to the foregoing, since the substance containing halogen is added into the water to be electrolyzed, thereby to cause the electrolyzed water to have the high concentration, the electrolyzed water with high concentration hypohalogenous acid and active oxygen can be easily obtained, so that the sterilizing effect can be further improved.

According to the electrolyzed water producing apparatus of the present invention, there is provided the portable discharge container including the reservoir portion for reserving the water to be electrolyzed, the pair of or the plurality of electrolyzing electrodes provided in the reservoir portion so as to be immersed in the water to be electrolyzed, and the discharge portion for discharging the liquid in the reservoir portion to the exterior, wherein the current is caused to flow in the electrolyzing electrodes to produce hypohalogenous acid and active oxygen in the water to be electrolyzed. Thus, by taking the discharge container in hands, the electrolyzed water produced in the reservoir portion can be easily discharged to a place where sterilization is required, thereby to easily sterilize such a place.

As a result, the usability of the electrolyzed water is improved. Further, since the electrolyzed water can be used immediately after production thereof from the water to be electrolyzed, the sterilizing effect is improved.

According to another aspect of the present invention, in addition to the foregoing, since the power supply portion for energizing the electrolyzing electrodes of the discharge container from the exterior is provided as a separate member from the discharge container, it is possible to reduce weight of the discharge container itself and also simplify the structure thereof. Further, since the discharge container is lightweight, the usability thereof is further improved.

According to another aspect of the present invention, in addition to the foregoing, since the discharge container is unified with the power supply for energizing the electrolyzing electrodes, the structure is simplified to reduce generation of failure.

According to another aspect of the present invention, in addition to the foregoing, since the controller is further provided for controlling energization of the electrolyzing electrodes, and further since the controller is capable of changing the concentration of the electrolyzed water produced in the reservoir portion, the concentrations of hypohalogenous acid and active oxygen can be adjusted depending on a purpose of using the electrolyzed water.

According to another aspect of the present invention, in addition to the foregoing, since the controller is provided in the power supply portion, it is possible to further reduce weight of the discharge container and further simplify the structure thereof.

According to another aspect of the present invention, in addition to the foregoing, the discharge container has the operating portion, and based on an operation of the operating portion, the electrolyzed water produced in the reservoir portion is forced into the discharge portion so as to be discharged in a spray manner. Thus, the discharge container can be improved in operatability thereof. Further, the electrolyzed water can be discharged from the discharge container without forming it into a state of mist, so that a user can be prevented from directly inhaling the electrolyzed water.

What is claimed is:

1. A sterilizing method characterized by performing sterilization using electrolyzed water containing hypohalogenous acid and active oxygen.

2. A sterilizing method according to claim 1, wherein electrolyzing electrodes are immersed in water to be electrolyzed, a current is caused to flow in said electrolyzing electrodes to produce hypohalogenous acid and active oxygen in said water to be electrolyzed, thereby to produce said electrolyzed water, then in a short term, the sterilization is performed using said electrolyzed water.

3. A sterilizing method according to claim 2, wherein a substance containing halogen is added into said water to be electrolyzed, thereby to cause said electrolyzed water to have a high concentration.

4. An electrolyzed water producing apparatus comprising:
a portable discharge container including a reservoir portion for reserving water to be electrolyzed, a pair of or a plurality of electrolyzing electrodes provided in said reservoir portion so as to be immersed in said water to be electrolyzed, and a discharge portion for discharging a liquid in said reservoir portion to the exterior,
wherein a current is caused to flow in said electrolyzing electrodes to produce hypohalogenous acid and active oxygen in said water to be electrolyzed.

5. An electrolyzed water producing apparatus according to claim 4, wherein a power supply portion for energizing the electrolyzing electrodes of said discharge container from the exterior is provided as a separate member from said discharge container.

6. An electrolyzed water producing apparatus according to claim 4, wherein said discharge container is unified with a power supply for energizing said electrolyzing electrodes.

7. An electrolyzed water producing apparatus according to claim 4, 5 or 6, further comprising a controller for controlling energization of said electrolyzing electrodes, wherein said controller is capable of changing a concentration of electrolyzed water produced in said reservoir portion.

8. An electrolyzed water producing apparatus according to claim 7, wherein said controller is provided in said power supply portion.

9. An electrolyzed water producing apparatus according to claim 4, 5, 6, 7 or 8, wherein said discharge container has an operating portion, and wherein, based on an operation of said operating portion, electrolyzed water produced in said reservoir portion is forced into said discharge portion so as to be discharged in a spray manner.
